(19) United States
(12) Patent Application Publication
(10) Pub. No.: US 2025/0185687 A1
(43) Pub. Date: Jun. 12, 2025

(54) FREEZE-DRIED FROYO BITES

(71) Applicant: Haskell Noah, Flushing, NY (US)

(72) Inventor: Haskell Noah, Flushing, NY (US)

(21) Appl. No.: 18/845,953

(22) PCT Filed: Oct. 7, 2021
(86) PCT No.: PCT/US2021/053981

§ 371 Date: Sep. 11, 2024

(51) Int. Cl. A23G 9/40; A23C 1/08; A23C 9/123; A23G 9/36; A23G 9/44

(52) U.S. Cl. CPC A23G 9/40; A23C 1/08; A23C 9/1232; A23G 9/363; A23G 9/44

(57) ABSTRACT

Methods for manufacturing a freeze-dried froyo bite snack product are provided. In some implementations, a method includes forming a blended froyo mix comprising frozen yogurt mix, a flavoring agent, and a quantity of probiotics sufficient to raise the level to a predetermined threshold. A filling machine may to deposit portions of the blended froyo mix into a plurality of silicone molds each comprising a plurality of recesses, which are then freeze-dried for a predetermined time. A demolding machine may be used to extract the individual units, which are further freeze-dried. The demolded frozen yogurt snack units may then be scanned for impurities or imperfections and bagged. In some implementations, the flavoring agent may be fresh fruit puree, concentrated fresh fruit puree, or freeze-dried fruit puree. In some implementations, the frozen yogurt mix may comprise pasteurized and cultured milk, water, sugar, stabilizers, and emulsifiers.

### PRIORITY CLAIM

This application claims priority to U.S. Patent Application No. 62/123,456, filed Oct. 7, 2020, and titled, “FREEZE-DRIED FROYO BITES,” the contents of which is incorporated by reference in its entirety.

### FIELD

The present disclosure relates generally to a method for manufacturing a freeze-dried frozen yogurt snack product.

### BACKGROUND

In embodiments of the invention, a freeze-dried frozen yogurt snack product is described as having a high probiotic concentration, vibrant flavor profile, and long shelf life.

Frozen yogurt is a desirable product, often having no fat in comparison to traditional ice cream and is lower in calories. Frozen yogurt is believed to have health benefits including enhanced immunity and can help reduce hypertension and osteoporosis. Frozen yogurt is also rich in probiotics, the “friendly” bacteria found in the human digestive system.

However, frozen yogurt is perishable and has a limited shelf life and must be at a minimum refrigerated to prevent spoilage and preferably frozen to take on the creamy texture akin to ice cream. Even under refrigerated conditions, the vibrancy of certain flavors is prone to fade with time, making the product less appealing.

What is thus needed is a frozen yogurt-based snack that provides the benefits of refrigerated or frozen yogurt in a product that requires no refrigeration or freezing, is shelf-stable, and is portable for on-the-go consumption.

What is further needed is a frozen yogurt-based snack that has an extended shelf life.

What is further needed is a frozen yogurt-based snack that is rich in probiotics to help support digestive health, immune health, and support protein utilization.

What is further needed is a frozen yogurt-based snack that has a bright and fresh flavor profile even after extended storage.

In this respect, before examining at least one embodiment of the invention in detail, it is to be understood that the invention is not limited in its application to the details of construction or manufacture and to the arrangements of the components or ingredients outlined in the following description or illustrated in the drawings. Also, it is understood that the phraseology and terminology employed herein are for the purpose of description and should not be regarded as limiting.

### SUMMARY

In some implementations, a method is disclosed for manufacturing a frozen yogurt snack product comprising a first step of forming a blended froyo mix by combining (a) a quantity of frozen yogurt mix, (b) a quantity of a flavoring agent and (c) a quantity of probiotics sufficient to raise the level to approximately one billion per 18-gram serving of the finished frozen yogurt snack product, in a mixer until the ingredients have been fully blended.

In some implementations, the method may include the further step of transferring the blended froyo mix from the mixer to a filling machine configured to deposit portions of the blended froyo mix into a plurality of silicone molds each comprising a plurality of recesses that are shaped as the negative of the desired shape of the finished frozen yogurt snack product.

In some implementations, the method may include the further step of forming a plurality of frozen yogurt snack units by transferring the filled silicone molds to a deep freezer until the blended froyo mix has frozen solid.

In some implementations, the method may include the further step of extracting the plurality of frozen yogurt snack units from the silicone molds by employing a demolding machine to applying a force to a closed side of the silicone molds, causing the frozen yogurt snack units to fall through an open side of the silicone molds.

In some implementations, the method may include the further step of freeze-drying the demolded frozen yogurt snack units for approximately 30-50 hours.

In some implementations, the method may include the further steps of scanning the demolded frozen yogurt snack units for impurities or imperfections and packaging the frozen yogurt snack units into a plurality of packages.

In some implementations, the quantity of frozen yogurt mix in the blended froyo mix is zero.

In some implementations, the flavoring agent is one of fresh fruit puree, concentrated fresh fruit puree, and freeze-dried fruit puree. In some implementations, the frozen yogurt mix comprises pasteurized and cultured milk, water, sugar, stabilizers, and emulsifiers. In some implementations, the probiotics are adapted to survive freeze-drying or are of the GanedenBC30 strain.

In some implementations, the mixing step is performed in a climate-controlled facility maintained at a temperature of approximately 35-55° F. and zero percent humidity. In some implementations, the mixer comprises a circulating pump that transfers the blended froyo mix frozen yogurt formula to the filling machine.

In some implementations, the recesses of the silicone molds are shaped like one of ice cream cones and swirls, fruit shapes, animals, cartoon characters, vehicles, cubes, and hemispheres.

In some implementations, a filling machine may be utilized to perform the further steps of: (a) using the filling machine to move the silicone molds along a conveyor from a start position to a filling assembly; (b) using a plurality of sensors to detect the presence of an empty silicone mold at the filling station; (c) using a controller in communication with the plurality of sensors to position, the empty silicone mold beneath the filling assembly; (d) filling the silicone mold with blended froyo mix using one or more nozzles; and (e) pumping unused blended froyo mix back to a storage tank connected to the filling assembly via a tubing system.

In some implementations, the nozzles may comprise one-way tips that inhibit leakage of the mix between fillings.

In some implementations, the deep freezer is a nitrogen tunnel freezer or nitrogen cabinet freezer comprising a conveyer.

### BRIEF DESCRIPTION OF THE DRAWINGS

The features and advantages of the present disclosure will be more fully understood with reference to the following detailed description when taken in conjunction with the accompanying figures, wherein:

FIG. 1 depicts a sample serving of a freeze-dried froyo bite in a consumer's hand against an exploded view of a single froyo bite unit, according to example embodiments of the present disclosure.

FIG. 2 depicts a flow diagram of an exemplary manufacturing process according to example embodiments of the present disclosure.

FIG. 3 depicts a selection of freeze-dried fruit powders according to example embodiments of the present disclosure.

FIG. 4 depicts an exemplary mold according to example embodiments of the present disclosure.

FIG. 5 depicts a process for forming a mold master according to example embodiments of the present disclosure.

FIG. 6 depicts a process for forming a silicone mold according to example embodiments of the present disclosure.

FIG. 7 depicts a step in a process for forming a silicone mold according to example embodiments of the present disclosure.

FIG. 8 depicts a schematic for an exemplary filling machine according to example embodiments of the present disclosure.

FIGS. 9-10 depict a demolding machine according to example embodiments of the present disclosure.

### DETAILED DESCRIPTION

In embodiments of the invention, a freeze-dried frozen yogurt snack product is described as having a high concentration of probiotics, long shelf life, and bright flavor profile even after extended storage. In embodiments of the invention, the frozen yogurt snack product—alternatively referred to herein as a frozen yogurt bite, froyo bite, or end product-takes the form of individual, miniature freeze-dried yogurt bites having a crunchy texture. The product may be offered in a variety of flavors including strawberry, blueberry, apricot, mango, raspberry, pineapple, tart, coffee, cookies and cream, and cotton candy, among others. In embodiments of the invention, a vegan or keto-friendly variation may be produced.

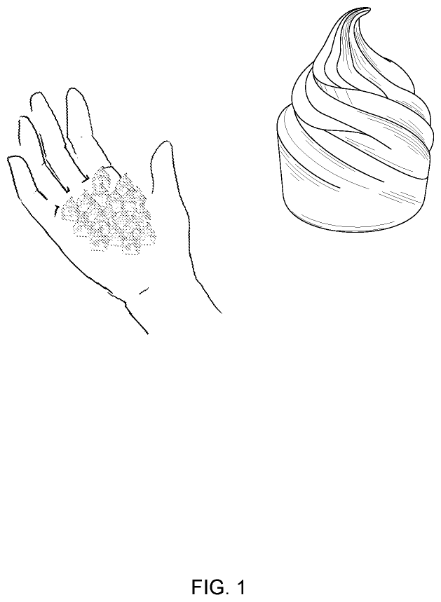

In embodiments of the invention, the froyo bite is formed in an aesthetically pleasing novelty shape such as a miniaturized serving of swirled frozen yogurt. FIG. 1 depicts such an embodiment, showing a sample serving in a consumer's hand against an exploded view of a single froyo bite unit. In a preferred embodiment, the frozen yogurt bite is approximately one gram in weight and measures 1.5 cm in width at the base and 2.5 cm in height from the base to the top of the swirl.

It will be understood that the finished product may vary in size, shape, and weight and that FIG. 1 is only one example.

### Overview of Manufacturing Process

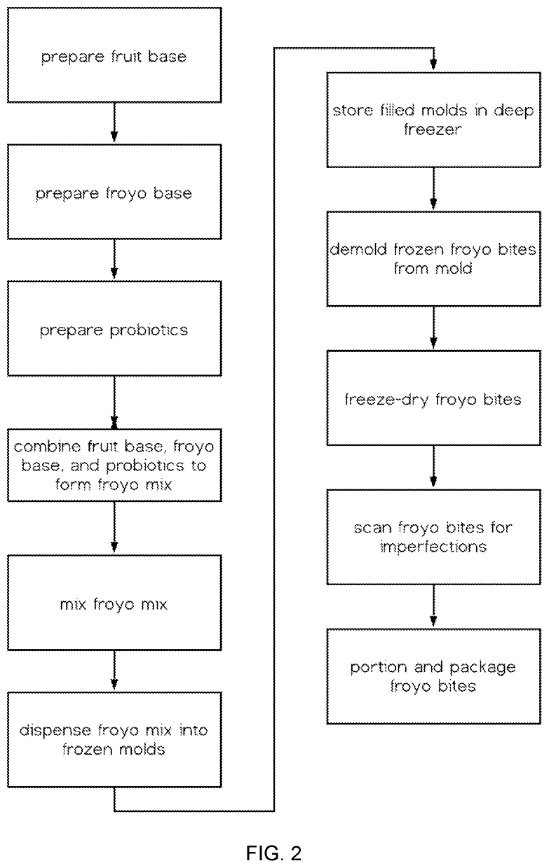

Referring to FIG. 2, an overview of an exemplary manufacturing process is described.

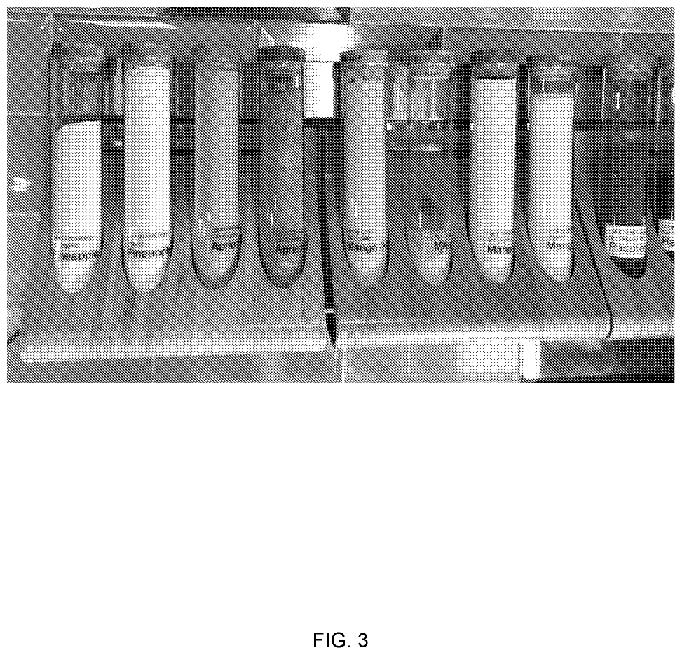

In a preferred embodiment, a fruit-based ingredient is first provided, preferably a fruit puree that has been freeze-dried or, alternatively, a liquid fruit puree. The fruit puree preferably comprises fresh fruit or fruit puree that has been freeze-dried either by an outside vendor or performed in-house using a custom fruit selection. A sample selection of freeze-dried fruit powders is shown in FIG. 3.

Next, a froyo mix may be generated by combining the freeze-dried fruit powder, yogurt, and probiotics. Water and air may be combined into the yogurt mix to adjust the consistency, accounting for the amount of water in the fresh puree, if used. Specific quantities and ratios for the mix are described below.

Molds having a recess in the shape of the desired end product are preferably frozen in advance. In a preferred embodiment, the molds comprise food-grade silicone with a recess that has been shaped for the desired end product (e.g., a soft-serve ice cream swirl, animal character, letter of the alphabet, etc.) The pre-frozen molds may then be filled with the yogurt mix using a custom filling machine described below to form a molded froyo mix. The molded froyo mix may then be stored in a deep freezer at approximately −16 to −35° C. for roughly 1-3 hours.

The frozen molds containing the formed and shaped molded froyo mix may then be removed from the deep freezer and emptied onto a tray, forming a plurality of froyo bites. In embodiments of the invention, a demolding device (described below) is used to empty the trays at a commercial scale. In other embodiments of the invention, the demolding may be performed manually.

In embodiments of the invention, the individual froyo bites may be subjected to a freeze-drying process for approximately 30-50 hours. The freeze-drying process removes water from the frozen yogurt bites, creating a product that is resistant to spoilage and stable in both texture and flavor.

Freeze drying—also known as lyophilization or cryodesiccation—is a form of dehydration performed at low temperature. In a typical freeze-drying process, the product is flash frozen and placed in a vacuum chamber that reduces the air pressure on the product and extracts the ice crystals in the product by sublimation. This is in contrast to dehydration by most conventional methods that evaporate water using heat. Freeze drying results in greater moisture removal than dehydration (98-99% versus 90-95%), resulting in longer shelf life, crunchier texture, and enhanced flavor, making it better suited for the present application.

Following freeze-drying, the frozen yogurt bites are scanned for imperfections and impurities using a metal detector or X-ray machine as they drop down from a hopper to a weighing and filling station.

The frozen yogurt bites may then be portioned and bagged, and the bags sealed before being packed into their secondary packaging and the master shipping carton and sent to a logistics department for distribution. The finished cartons are then transferred to a logistics department for distribution, either to retail locations or direct to consumers.

### Ingredients

As discussed above, a froyo bite snack product may comprise freeze-dried fruit powder; frozen yogurt; and probiotics.

In embodiments of the invention, a frozen yogurt preparation-referred to as froyo-may be used as the base of the frozen yogurt snack product. Yogurt is a mixture of milk that has been fermented by a type of culture that produces lactic acid. Froyo is a special formulation of that yogurt that is particularly adapted for frozen yogurt applications and capable of forming a creamy product similar to ice cream. Once processed and aerated, the product may be ready for consumption.

It has been found that Scott Brothers Dairy in Chino, California produces a frozen yogurt mix that is particularly suited for the present invention. That frozen yogurt mix may itself include a range of ingredients such as pasteurized and cultured skim milk, water, sugar, corn syrup, natural flavors, maltodextrin, stabilizers, emulsifiers, citric acid, disodium phosphate, and live and active cultures.

Frozen yogurt mix is sold in either powder form that requires water or in liquid form that is ready to pour into a soft-serve machine. A mix with high or low-fat content can be chosen, and the amount of air introduced into the soft-serve frozen yogurt is variable. Here, a liquid form is preferred for use with the present invention. In a preferred embodiment, a non-fat variety of froyo mix was used.

The freeze-dried fruit powder may comprise fresh fruit or fruit puree concentrate that has been subjected to a freeze-drying process, and then finely ground. Freeze-dried fruit powder may be sourced in bulk or freeze-dried in-house. In embodiments of the invention, the freeze-drying process may be outsourced to a third-party vendor that converts fresh fruit or fruit puree to powder form.

In embodiments of the invention, probiotics in a powder form are also added to the mix. Probiotics are foods or supplements that contain live microorganisms intended to maintain or improve the “good” bacteria (normal microflora) in the body. Probiotics have been found to help support digestive health, immune health, and may help support protein utilization.

The GanedenBC30 (Bacillus coagulans GBI-30, 6086) probiotic strain is particularly well suited for the present invention because of its protective outer layer that helps the probiotic survive harsh processing conditions that would kill off other strains. In addition, it has been further found that GanedenBC30 supports digestive health when consumed daily, creating a healthier intestinal environment, and supporting immune function.

### The Process

The steps in taking the frozen yogurt snack mix to a finished product ready for consumption will now be described.

In a preferred embodiment, the freeze-dried fruit puree, froyo, probiotics, and air (via the introduction of water) are combined to create frozen yogurt formula. Alternatively, water may be omitted where fruit puree is used since the puree already contains a significant amount of water. The specific formula and ratios for the frozen yogurt formula may depend on the particular flavor or end product. A sample formulation for a strawberry-flavored end product is shown below:

TABLE 1
Strawberry Formulation

| | | | % solids | % solids |
|---|---|---|---|---|
| | | | (pre- | (post- |
| | weight | % by | freeze- | freeze- |
| | (g) | weight | drying) | drying) |
| frozen yogurt mix | 100 | 78.596 | 29.23 | 29.23 |
| strawberry | 22.5 | 17.6841 | 28 | 6.3 |
| concentrate (28° | | | | |
| brix) | | | | |
| GanedenBC30 | 0.133 | 0.10453 | 100 | 0.133 |
| Total | 127.233 | 100 | | 35.663 |

As described in the above sample formulation, 100 grams of frozen yogurt mix was combined with 22.5 grams of strawberry concentrate mix rated at 28° brix. (It will be understood by those having ordinary skill in the art that a brix value represents the relative sweetness or sugar content of an aqueous substance. One degree of brix is equal to one gram of sucrose in a 100-gram sample.) Lastly, 0.133 grams of the powdered GanedenBC30 probiotic was added to the mix for a total batch size of 127.233 grams. In this example, a strawberry puree concentrate was used.

It will be appreciated by those having ordinary skill in the art that the choice of using fresh fruit versus fruit puree versus fruit powder will depend on factors related to availability, stability, and water content, among others. The choice of base fruit should be accounted for in the formulation since certain fruits and concentrates have higher water volume than others.

For example, a fresh fruit puree such as mango puree will have a higher water content than a concentrate. The moisture content of the fruit must be considered in the ingredient ratio. Concentrated puree can be easier to obtain, more consistent in terms of sweetness, and easier to incorporate since the puree can be combined directly with the froyo.

As an example of how the modifying the base fruit can impact the formulation, a sample mango formulation is shown in below incorporating fresh fruit puree:

TABLE 2
Mango Formulation

| | | | % solids | % solids |
|---|---|---|---|---|
| | | | (pre- | (post- |
| | weight | % by | freeze- | freeze- |
| | (g) | weight | drying) | drying) |
| frozen yogurt mix | 100 | 72.657 | 29.23 | 29.23 |
| fruit puree | 39.15 | 27.2464 | 16 | 6.276 |
| (brix?) | | | | |
| GanedenBC30 | 0.133 | 0.09663 | 100 | 0.133 |
| Total | 139.283 | 100 | | 35.633 |

Here, a 139.283-gram sample utilized 39.15 grams of mango puree or approximately 27.35%. This is in contrast to the strawberry formulation above in which the 22.5 grams of strawberry concentrate accounted for only 17.68% of the total sample.

In a preferred embodiment, a freeze-dried fruit powder may be used rather than a fruit puree or concentrate. It has been found in testing that a freeze-dried fruit powder has a lower moisture content than concentrates or purees, resulting in a stronger taste and denser product. This may enhance the taste of the end product by enhancing the fruit flavor and enhance the texture of the end product by increasing the crunchiness. In test embodiments, a premium end product was created using freeze-dried fruit powder to create a more “blueberry tasting” end product or more “strawberry tasting” end product.

In embodiments of the invention, a quantity of probiotics may be added to raise the level to approximately one billion per 18-gram serving. Probiotics are foods or supplements that contain live microorganisms intended to maintain or improve the so-called “good” bacteria in the body. Probiotics have been found to help support digestive health, immune health, and may help support protein utilization. One billion probiotics per serving are within the recommended range for maintaining digestive health and obtaining the health benefits of the microbes.

As referenced above, it has been found that the GanedenBC30 (Bacillus coagulans GBI-30, 6086) probiotic strain is particularly well suited for the present invention because of its protective outer layer that helps the probiotic survive harsh processing conditions that would kill off other strains. It has been further found that GanedenBC30 supports digestive health when consumed daily, creating a healthier intestinal environment, and supporting immune function requires probiotics that survive the harsh manufacturing process.

In an analysis of the GanedenBC30 probiotic, it was found that a minimal die-off of the cultures occurred after as much as four months in storage. Because the end product is freeze-dried and has an extended shelf life generally, the probiotics must be able to similarly survive and offer health benefits months after the product has been manufactured and shipped.

The protective outer layer of the GanedenBC30 probiotic helps it survive the harsh processing conditions that can occur during manufacturing, including exposure to heat, light, freeze-drying, and other environmental conditions.

The ingredients comprising the froyo mix may then be combined and blended. In a preferred embodiment, a 20-gallon mixer fitted with a hopper receives the ingredients and is used to blend the weighed ingredients for approximately 3-5 minutes. The mixer may have a circulating pump that flushes the frozen yogurt formula from the hopper and mixes the ingredient for a predetermined time or until the ingredients have been fully blended.

Besides variations in flavor and mix-ins, alternate formulations are contemplated as coming within the scope of the invention. For example, an embodiment may omit the frozen yogurt mix element entirely and comprise only fruit puree and, optionally, probiotics. The remaining steps in the process may remain the same, leaving a freeze-dried non-dairy “bite,” possibly in the shape of the underlying fruit.

In embodiments, the mixing occurs in a climate-controlled room that is maintained at a temperature of approximately 35-55° and very low humidity, preferably zero percent. It has been found that the pumps, condensers, and even washing stations for washing equipment may generate heat and humidity that can compromise the process and should be accounted for.

Once the mixing process is complete, the frozen yogurt formula may be transitioned to a filling machine that deposits the frozen yogurt mix into the silicone molds.

In embodiments of the invention, the frozen yogurt formula is dispensed into pre-formed silicone molds containing a plurality of recesses that are shaped as the negative of the desired shape of the end product using a 3D-printed master.

Food-grade silicone is an elastomer having many characteristics of a polymer, making it a hybrid between synthetic rubber and plastic. Food-grade silicone exhibits high tensile strength and high resiliency when subjected to repeated movements such as the demolding step of the present invention. Further, food-grade silicone exhibits minimal shrinkage during curing and is thus able to reproduce the fine details of the molded finished product. In embodiments of the invention, the end product exhibits fine detail making silicone an appropriate choice. It will be appreciated that alternative molding materials are possible and within the scope of the present invention.

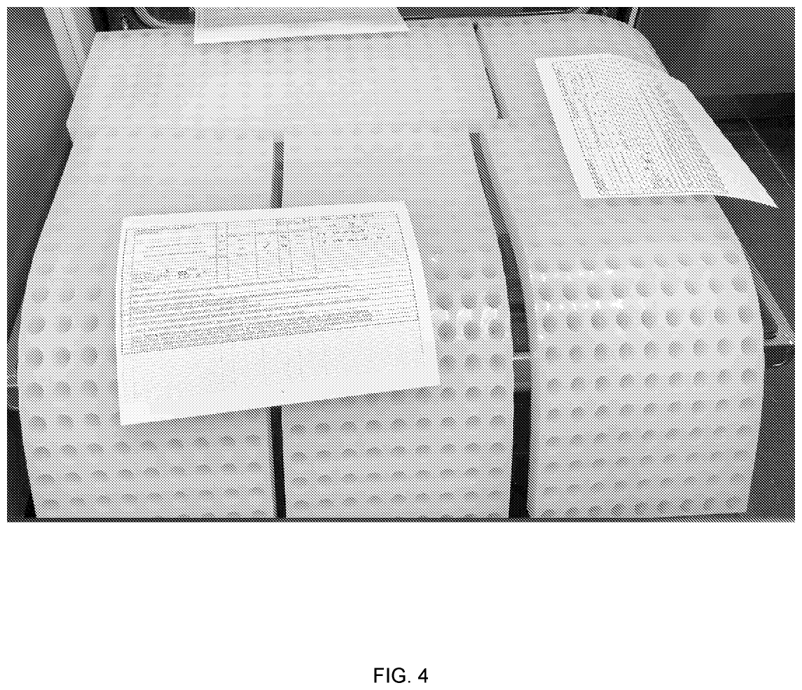

In embodiments, a mold is prepared to hold the froyo mix during the freezing steps. In an exemplary embodiment, the mold is a piece of food-grade silicone that has been formed with a plurality of cavities or compartments organized in rows and columns. The compartments in the silicone mold may be formed in the shape of the negative of the shape of the end product such that a unit of frozen yogurt formula takes the shape of the compartment. An exemplary mold is shown in FIG. 4.

The molds may be sourced or custom-made. Where a custom shape for the end product is desired, a mold may be fabricated beginning with a frozen yogurt master or master.

The masters will generally correspond in appearance and size to the finished frozen yogurt snack product and will form the negative in the silicone mold. Before depositing the uncured silicone mix into the mold frame, a plurality of masters may be formed.

In the first step, a master template is rendered and created using conventional 3D printing technology. In embodiments, a sufficient quantity of masters is generated to establish at least one mold and, more preferably, multiple molds. In a prototype embodiment, a mold having 171 compartments was formed using 171 3D-printed masters.

It will be appreciated that the possible shapes for the master are virtually limitless, including ice cream cones and swirls, fruit shapes, animals, cartoon characters, vehicles, cubes, hemispheres, and so on. The selected shape should minimize details that might make extraction from the mold difficult or contain elements that might break off during extraction.

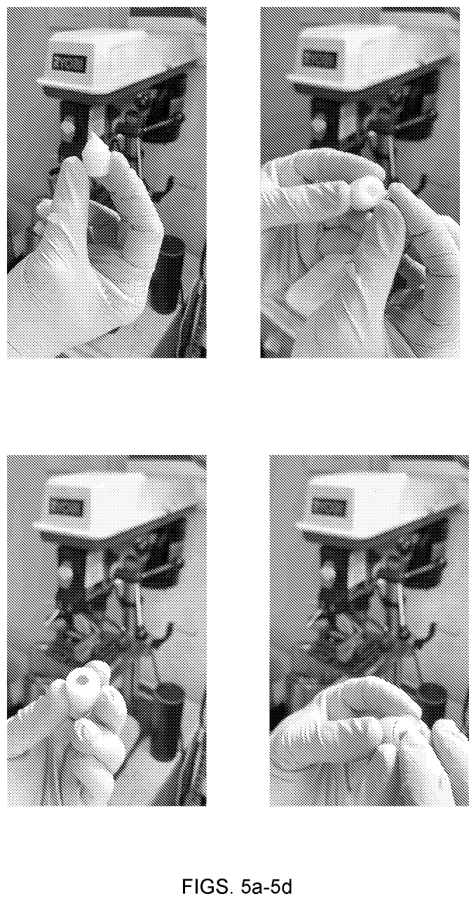

FIGS. 5a-5d depict the steps in forming the master.

The masters may then be magnetized to facilitate placement and alignment in the tooling or silicone frame and to ensure that the master remains upright in the tooling. A hole may be drilled in the base of each master and a magnet fitted in the hole. The magnet may be permanently secured by a press-fit or adhesive. An optional gasket may then be secured to the base of the master to further aid in placement, removal, and filling of the silicone mold.

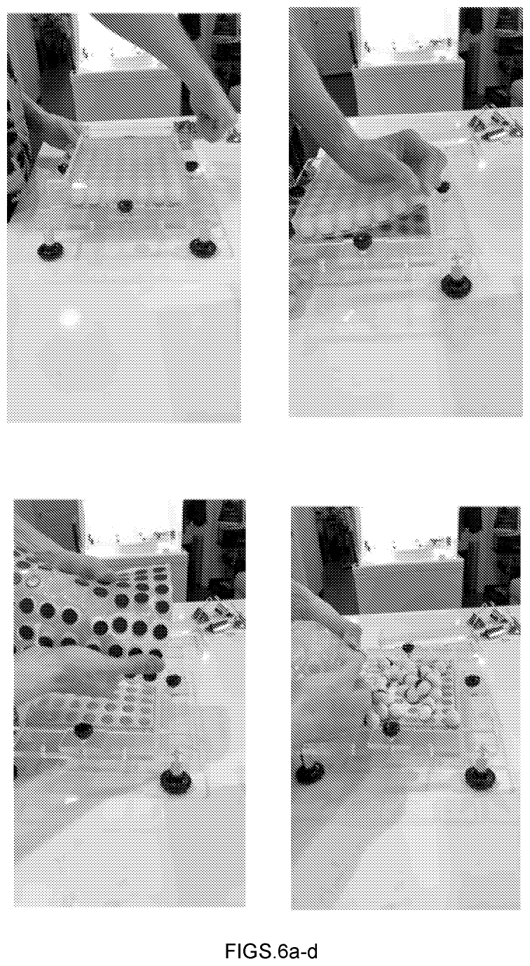

Tooling may be formed to receive and hold the silicone mix during curing. In embodiments, a Plexiglass (also referred to as acrylic glass or acrylic) frame may be provided to contain the pre-cured silicone mix. FIGS. 6a-6d depict one such exemplary mold in which the frame components were joined together using clips.

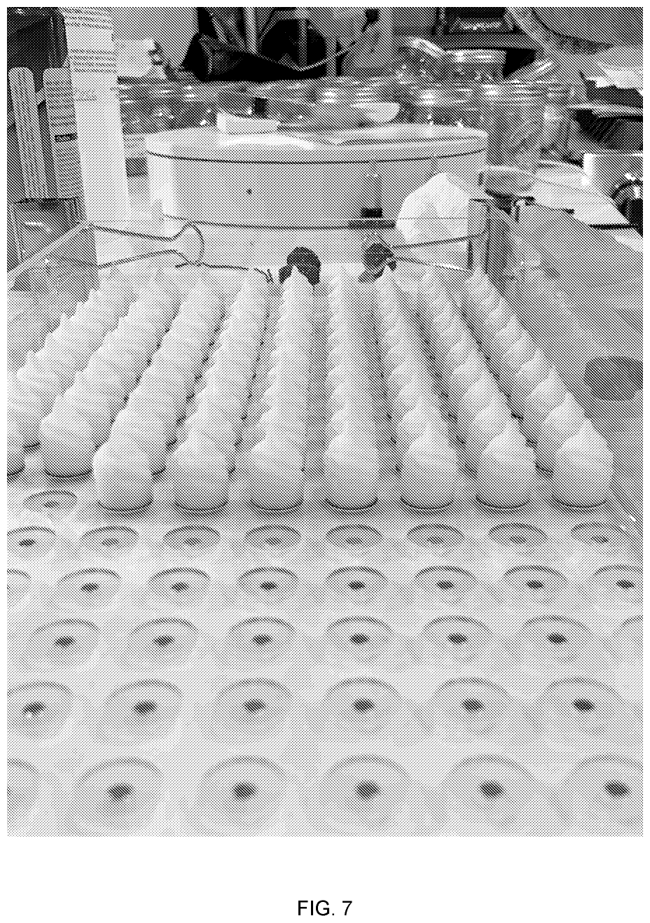

In embodiments, the frame components may be joined together permanently or semi-permanently using adhesive or silicone. A bottom panel may then be provided to form a rectangular basin, and a metallic layer added that is selectively magnetized to correspond to the desired layout of the finished mold. Magnets fitted in the base of each master will be attracted to select regions in the base to maintain alignment and spacing during filling. FIG. 7 shows such a configuration.

In embodiments, a silicone mix is prepared according to the manufacturer's instructions, typically comprising an A component and a B component. In embodiments, the A and B components are mixed in equal parts, though some formulations use a different ratio and must be mixed by weight.

In a prototype embodiment, a mix of Elkem RTV-4410 silicone elastomer was used. A 2,650-gram sample of RTV-4410 component A was mixed with the same quantity of component B and mixed for two minutes. The mix was then cured for 6 hours at room temperature, resulting in the mold shown in FIGS. 6a-6d.

In another embodiment, SORTA-Clear 18 by Smooth-On of Macungie, PA was used. SORTA-Clear 18 is a certified food-safe two-component silicone rubber that cures at room temperature. In a prototype embodiment, components A and B were mixed in a 100:10 ratio and then cured for 24 hours at room temperature.

An optional release agent may be applied to the masters to facilitate the separation of the masters and the mold.

In an alternative embodiment, a compression molding system may be used to generate the silicone molds, which will enable more complex shapes and intricate details in the molds and resulting froyo bites.

### Filling Machine

In embodiments of the invention, the cured silicone molds are moved to a custom filling machine where the individual compartments are filled with the froyo mix.

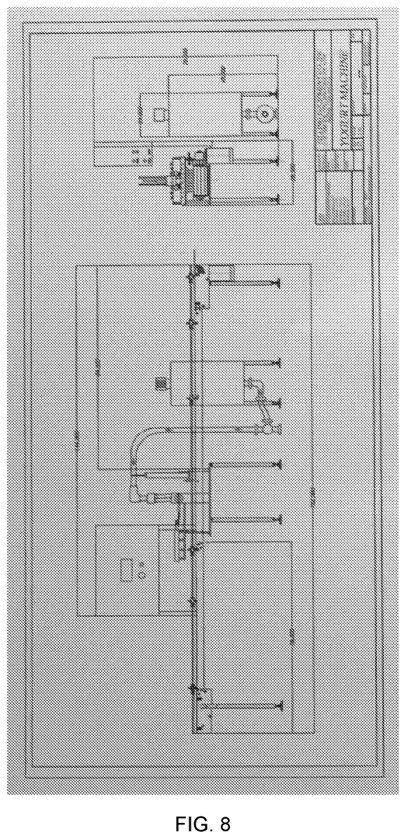

Referring to FIG. 8, a schematic for an exemplary filling machine is shown. A filling machine comprises a lateral chain looping conveyor for moving filled silicone molds from a start position, along a track to a filling assembly where the individual compartments are filled, and onward to the next step in the manufacturing process. A tank containing frozen yogurt formula is provided and connected to the filling assembly via a tubing system that can pump the frozen yogurt formula to the filling head assembly and returns unused formula to the tank.

In embodiments, a conveyor is configured to move a silicone mold along a first axis while maintaining the position of the mold along a second axis. This configuration allows the mold to move toward the filling station and onward while remaining aligned beneath the filling assembly at the filling step.

One or more sensors are provided and configured to detect the presence of an empty mold at the filling station. When the sensor(s) is triggered and a mold is detected, the controller moves the conveyor to position the mold beneath the filling assembly, with the filling heads in alignment with the mold and its empty compartments. The conveyor is then paused.

A piston assembly pumps the frozen yogurt formula from the mixing tank to the filling assembly. An eye sensor in the filling assembly, in conjunction with the controller, scans the silicone mold for empty compartments and where one is detected, the controller directs the dispensation of a predetermined quantity of frozen yogurt mix into the compartment. The process is then repeated until all compartments have been filled.

In embodiments, a plurality of nozzles may be provided to simultaneously fill compartments in the mold and increase the speed of production. All nozzles may operate at once or the controller may direct that fewer than all nozzles operate.

In embodiments, a piston drive system draws in the frozen yogurt formula from the mixing tank to the filling assembly and back to the mixing tank. In embodiments of the invention, a servo motor may be used to control the position of the filling assembly.

The nozzles may be fitted with one-way tips that inhibit leakage of the mix between fillings.

After the molds have been filled with frozen yogurt formula, they are then placed in a deep freezer for 1-3 hours to set the frozen yogurt formula and allow the units to be extracted from the mold before freeze-drying. In embodiments, the units may be freeze-dried prior to extraction from the molds.

In embodiments, racks of molded frozen yogurt formula are wheeled into a blast freezer at a temperature of −16° to −35° F. for approximately 1-3 hours or until the frozen yogurt bites are frozen solid.

In an alternate embodiment of the invention, a nitrogen tunnel freezer or nitrogen cabinet may be used to freeze the molds as part of a continuation of the filling machine conveyor or an assembly line. In such an embodiment, a nitrogen tunnel freezer quick-freezes or chills product as it is moved along a conveyor through a tunnel, exposing the surfaces of the product and molds to cold nitrogen gas, making it especially suitable for a scaled-up commercial manufacturing environment where it is desirable to operate continuously or near-continuously.

The trays containing the frozen yogurt bites may then be transferred to a demolding machine where they can be extracted from the molds.

In a demolding step, the bottom side of the molds is pushed to extract the frozen yogurt bites at the open side of the mold.

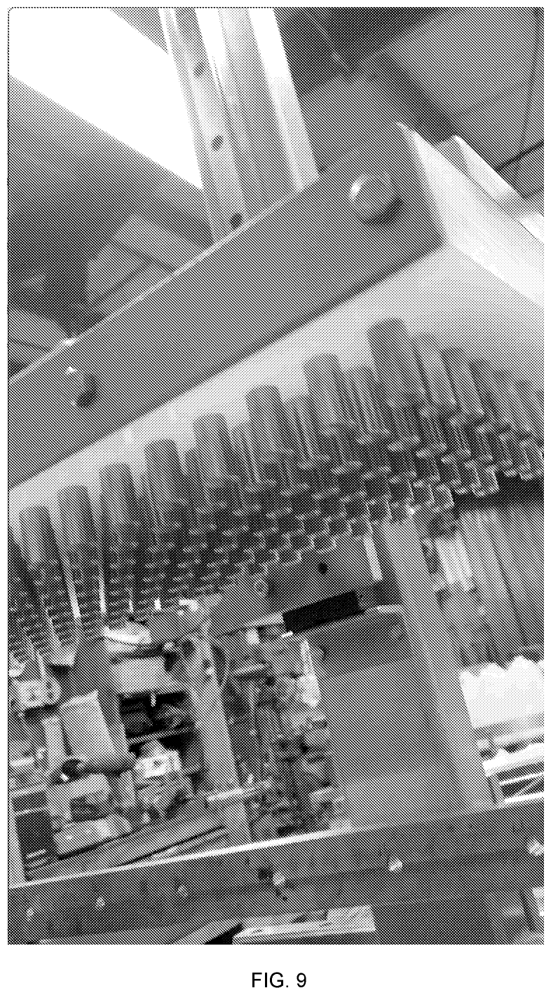

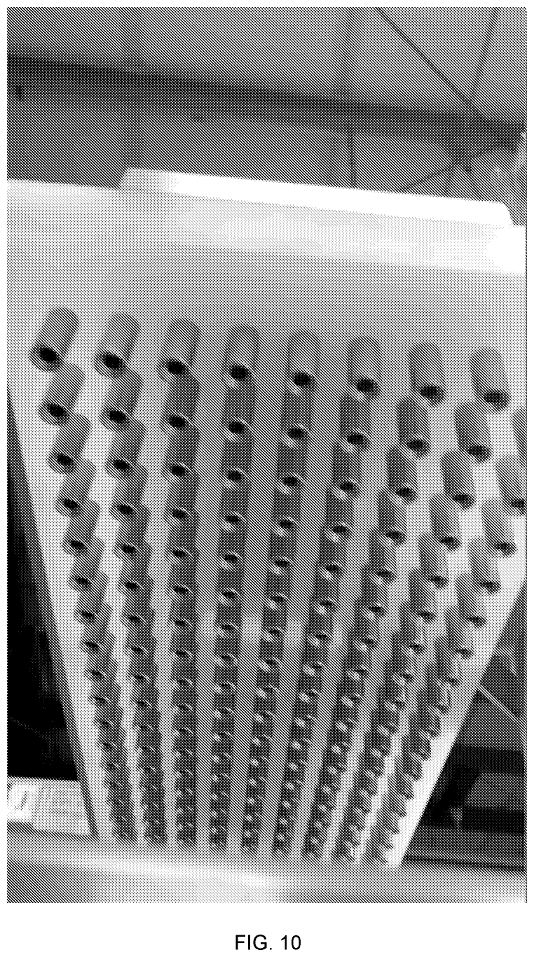

An exemplary custom demolding machine is shown in FIGS. 9-10. In operation, a plate comprising a plurality of stainless-steel bits is attached via a linear bearing to a linear track that permits the plate to move up and down under compressed air. The number and position of the bits correspond to the compartments in the mold, and an exemplary plate is shown in FIGS. 9-10.

In embodiments, the bits may be formed with a recess at the tip to avoid contacting select areas of the frozen yogurt bite and causing breakage. This is particularly useful in embodiments where the end product is shaped like a swirled serving of frozen yogurt and has a distinctive swirl tip. The compressed air causes the plate and bits to come into contact with the underside of the mold and push the frozen yogurt bites out of the mold.

The demolded frozen yogurt bites may then be subjected to a freeze-drying process for approximately 30-50 hours.

Immediately after the freeze-drying process is over remove the freeze-dried frozen yogurt bites from the freeze drier and without delay proceed to the bagging station where the units may be scanned for imperfections, impurities, and contaminants. In embodiments, the scanning step may take place while the units are falling from a hopper.

The units than may be packed, put into secondary packaging, and shipped to fulfillment.

What follows are additional formulas for use with the present invention:

TABLE 3
Raspberry Formulation

| | | | % solids | % solids |
|---|---|---|---|---|
| | | | (pre- | (post- |
| | weight | % by | freeze- | freeze- |
| | (g) | weight | drying) | drying) |
| frozen yogurt mix | 100 | 79.2814 | 29.23 | 29.23 |
| fruit concentrate | 22.5 | 16.9662 | 28 | 6.3 |
| (28° brix) | | | | |
| GanedenBC30 | 0.133 | 0.10544 | 100 | 0.133 |
| Total | 122.633 | 100 | | 35.663 |

Referring to Table 3, a raspberry-flavored formulation was created using 100 grams of frozen yogurt mix was combined with 22.5 grams of raspberry concentrate mix rated at 28° brix. Lastly, 0.133 grams of the powdered GanedenBC30 probiotic was added to the mix for a total batch size of 122.633 grams. In this example, a raspberry concentrate was used.

TABLE 4
Blueberry Formulation

| | | | % solids | % solids |
|---|---|---|---|---|
| | | | (pre- | (post- |
| | weight | % by | freeze- | freeze- |
| | (g) | weight | drying) | drying) |
| frozen yogurt mix | 100 | 79.2814 | 29.23 | 29.23 |
| puree concentrate | 22.5 | 16.9662 | 100 | 6.3 |
| (28° brix) | | | | |
| GanedenBC30 | 0.133 | 0.10544 | 100 | 0.133 |
| Total | 122.633 | 100 | | 35.663 |

As described in the above sample formulation, 100 grams of frozen yogurt mix was again combined with 22.5 grams fruit concentrate mix—here, blueberry—rated at 28° brix. Lastly, 0.133 grams of the powdered GanedenBC30 probiotic is added to the mix for a total batch size of 127.233 grams. In this example, a blueberry concentrate was used.

TABLE 5
Apricot Formulation

| | | | % solids | % solids |
|---|---|---|---|---|
| | | | (pre- | (post- |
| | weight | % by | freeze- | freeze- |
| | (g) | weight | drying) | drying) |
| frozen yogurt mix | 100 | 83.2411 | 29.23 | 29.23 |
| puree concentrate | 20 | 16.6482 | 31.5 | 6.3 |
| (31.5° brix) | | | | |
| GanedenBC30 | 0.133 | 0.11071 | 100 | 0.133 |
| Total | 120.133 | 100 | | 35.663 |

As described in the above sample formulation, 100 grams of frozen yogurt mix was combined with 20 grams of concentrated apricot puree rated at 31.5° brix. Lastly, 0.133 grams of the powdered GanedenBC30 probiotic is added to the mix for a total batch size of 120.133 grams. In this example, the apricot was in the form of a concentrated puree.

It will be understood that there are numerous modifications of the illustrated embodiments described above which will be readily apparent to one skilled in the art, including any other combinations of ingredients or features disclosed, explicitly including additional combinations of such features. Steps may be re-ordered or omitted entirely. These modifications and/or combinations fall within the art to which this invention relates and are intended to be within the scope of the claims, which will follow. It is noted, as is conventional, the use of a singular element in a claim is intended to cover one or more of such an element.

We claim:

1. A method for manufacturing a frozen yogurt snack product comprising:
forming a blended froyo mix by combining (a) a quantity of frozen yogurt mix, (b) a quantity of a flavoring agent and (c) a quantity of probiotics sufficient to raise the level to approximately one billion per 18-gram serving of the finished frozen yogurt snack product, in a mixer until the ingredients have been fully blended;
transferring the blended froyo mix from the mixer to a filling machine configured to deposit portions of the blended froyo mix into a plurality of silicone molds each comprising a plurality of recesses that are shaped as the negative of the desired shape of the finished frozen yogurt snack product;
forming a plurality of frozen yogurt snack units by transferring the filled silicone molds to a deep freezer until the blended froyo mix has frozen solid;
extracting the plurality of frozen yogurt snack units from the silicone molds by employing a demolding machine to applying a force to a closed side of the silicone molds, causing the frozen yogurt snack units to fall through an open side of the silicone molds;
freeze-drying the demolded frozen yogurt snack units for approximately 30-50 hours;
scanning the demolded frozen yogurt snack units for impurities or imperfections; and
packaging the frozen yogurt snack units into a plurality of packages.

2. The method for manufacturing a frozen yogurt snack product of claim 1 further wherein the flavoring agent is one of: fresh fruit puree, concentrated fresh fruit puree, and freeze-dried fruit puree.

3. The method for manufacturing a frozen yogurt snack product of claim 1 further wherein the frozen yogurt mix comprises pasteurized and cultured milk, water, sugar, stabilizers, and emulsifiers.

4. The method for manufacturing a frozen yogurt snack product of claim 1 further wherein the probiotics are adapted to survive freeze-drying.

5. The method for manufacturing a frozen yogurt snack product of claim 1 further wherein the probiotics are of the GanedenBC30 strain.

6. The method for manufacturing a frozen yogurt snack product of claim 1 further wherein the mixing step is performed in a climate-controlled facility maintained at a temperature of approximately 35-55° F. and zero percent humidity.

7. The method for manufacturing a frozen yogurt snack product of claim 1 further wherein the mixer comprises a circulating pump that transfers the blended froyo mix frozen yogurt formula to the filling machine.

8. The method for manufacturing a frozen yogurt snack product of claim 1 further wherein the recesses of the silicone molds are shaped like one of: ice cream cones and swirls, fruit shapes, animals, cartoon characters, vehicles, cubes, and hemispheres.

9. The method for manufacturing a frozen yogurt snack product of claim 1 further wherein the quantity of frozen yogurt mix in the blended froyo mix is zero.

10. The method for manufacturing a frozen yogurt snack product of claim 1 wherein the method further comprises the steps of:
(a) using the filling machine to move the silicone molds along a conveyor from a start position to a filling assembly;
(b) detecting, using a plurality of sensors in the filling machine, the presence of an empty silicone mold at the filling station;
(c) positioning, using a controller in communication with the plurality of sensors, the empty silicone mold beneath the filling assembly;
(d) filling the silicone mold with blended froyo mix using one or more nozzles; and
(e) pumping unused blended froyo mix back to a storage tank connected to the filling assembly via a tubing system.

11. The method for manufacturing a frozen yogurt snack product of claim 1 further wherein the nozzles comprise one-way tips that are configured to inhibit leakage of the mix between fillings.

12. The method for manufacturing a frozen yogurt snack product of claim 1 further wherein the deep freezer is a nitrogen tunnel freezer or nitrogen cabinet freezer comprising a conveyer.
